(19) United States
(12) Patent Application Publication
(10) Pub. No.: US 2011/0035290 A1
(43) Pub. Date: Feb. 10, 2011

(54) SYSTEM AND METHOD FOR TRANSFERRING MONEY FROM A MOBILE PHONE ACCOUNT

(76) Inventors: Diego Franco Mortillaro, Meina (Novara) (IT); Marko Maras, Milan (IT)

Correspondence Address: HOLLAND & KNIGHT LLP, 10 ST. JAMES AVENUE, BOSTON, MA, 02116-3889, US

(21) Appl. No.: 12/538,481

(22) Filed: Aug. 10, 2009

(51) Int. Cl. G06Q 30/00; G06Q 40/00

(52) U.S. Cl. 705/26.1; 705/42

(57) ABSTRACT

A computer-implemented method, computer program product, and system for establishing an association between a mobile phone account of a user and a consumer debit account of the user. A first transfer of funds is effectuated from the mobile phone account to the consumer debit account. A second transfer of funds from the consumer debit account to a third party is enabled using at least a portion of the first transferred funds.

### TECHNICAL FIELD

This disclosure relates to money transfer systems and, more particularly, to electronic money transfer systems funded by mobile phone credit.

### BACKGROUND

In the past decade, the use of mobile phones has increased substantially. Current mobile phones may allow for both voice and data communication. Specifically, in addition to the standard voice function of a mobile phone, current mobile phones may support many additional services and accessories, such as SMS for text messaging, email, packet switching for access to the Internet, gaming, Bluetooth, still camera, video recorder, MMS for sending and receiving photos and video, MP3 player, radio and GPS, for example.

A mobile network operator (e.g., a carrier service provider, a wireless service provider, a wireless carrier, a mobile phone operator, or cellular company) is a telephone company that provides voice and data communication services that are delivered and consumed through a mobile phone. A mobile phone subscriber is a private user that undertakes a commercial relationship with a mobile network operator in order to access voice and data services delivered and consumed through a mobile phone. A Subscriber Identity Module (SIM) on a removable card (SIM card) securely stores the service-subscriber key (IMSI) used to identify a subscriber on a mobile phone. The SIM card allows users to change phones by simply removing the SIM card from one mobile phone and inserting it into another mobile phone. The MSISDN is a number uniquely identifying a subscription in a mobile network (e.g., the telephone number associated with the subscription).

Mobile phone subscribers may access the services of a mobile network operator either through a pre-paid or a post-paid contract. With a pre-paid SIM card (also commonly referred to as pay-as-you-go), the voice/data service is purchased in advance of use. By purchasing credit to use on a mobile phone network, a user can access a mobile phone network without ongoing billing. Users can then use the mobile phone network until they run out of credit. When out of credit, the user may add money to their SIM card for future data and voice time.

With a post-paid SIM card, the voice/data service is provided by a prior arrangement with a mobile network operator. The user may then be subsequently billed in accordance with the usage of their mobile phone. Typically, the customer's contract specifies a limit or “allowance” of minutes, text messages etc., and the customer may be billed at a flat rate for any usage equal to or less than that allowance. Any usage above that limit may incur extra variable charges (e.g., pay-per-minute of conversation; pay-per-text message sent/received; pay per MMS sent/received; and pay-per-kilobyte downloaded).

Electronic fund transfers or EFTs refer to computer-based electronic transfer of funds from a first financial account to a second financial account. Examples of EFT transactions may include but are not limited to: Sales (e.g., payments for a good/service); Refunds (e.g., the refunding of an earlier payment from a merchant to a purchaser); Withdrawals (e.g., the withdrawal of funds from an account); Deposits (e.g., a deposit of funds into an account); Cashback (e.g., a withdrawal of supplemental funds from an account at the time that a purchase is made); Inter-account transfers (e.g., the transfer of funds between linked accounts); and Payment (e.g., the transfer of funds to a third-party account).

### SUMMARY OF DISCLOSURE

In a first implementation, a computer-implemented method includes establishing an association between a mobile phone account of a user and a consumer debit account of the user. A first transfer of funds is effectuated from the mobile phone account to the consumer debit account. A second transfer of funds from the consumer debit account to a third party is enabled using at least a portion of the first transferred funds.

One or more of the following features may be included. Establishing an association may include defining a mobile device for the mobile phone account. Establishing an association may further include defining a telephone number for the mobile device. Establishing an association may further include defining a mobile network for the mobile device.

Effectuating a first transfer of funds may include effectuating a first transfer of funds via a web browser. Effectuating a first transfer of funds may include effectuating a first transfer of funds via text message.

Enabling a second transfer of funds may include enabling a second transfer of funds via a web browser. Enabling a second transfer of funds may include enabling a second transfer of funds via text message.

Enabling a second transfer of funds from the consumer debit account to a third party may include receiving an indication of an intent to make a purchase of a good/service, determining a price of the good/service, and comparing the price of the good/service to a balance of the consumer debit account. Enabling a second transfer of funds from the consumer debit account to a third party may further include, if the price of the good/service is greater than the balance of the consumer debit account, notifying the user of the shortage. Enabling a second transfer of funds from the consumer debit account to a third party may further include, if the price of the good/service is greater than the balance of the consumer debit account, enabling the user to transfer supplemental funds from the mobile phone account to the consumer debit account.

Effectuating a transfer of funds from the mobile phone account to the consumer debit account may include effectuating a transfer of funds as an aggregate of one or more predefined fund transfer amounts.

In another implementation, a computer program product resides on a computer readable medium that has a plurality of instructions stored on it. When executed by a processor, the instructions cause the processor to perform operations including establishing an association between a mobile phone account of a user and a consumer debit account of the user. A first transfer of funds is effectuated from the mobile phone account to the consumer debit account. A second transfer of funds from the consumer debit account to a third party is enabled using at least a portion of the first transferred funds.

One or more of the following features may be included. Establishing an association may include defining a mobile device for the mobile phone account. Establishing an association may further include defining a telephone number for the mobile device. Establishing an association may further include defining a mobile network for the mobile device.

Effectuating a first transfer of funds may include effectuating a first transfer of funds via a web browser. Effectuating a first transfer of funds may include effectuating a first transfer of funds via text message.

Enabling a second transfer of funds may include enabling a second transfer of funds via a web browser. Enabling a second transfer of funds may include enabling a second transfer of funds via text message.

Enabling a second transfer of funds from the consumer debit account to a third party may include receiving an indication of an intent to make a purchase of a good/service, determining a price of the good/service, and comparing the price of the good/service to a balance of the consumer debit account. Enabling a second transfer of funds from the consumer debit account to a third party may further include, if the price of the good/service is greater than the balance of the consumer debit account, notifying the user of the shortage. Enabling a second transfer of funds from the consumer debit account to a third party may further include, if the price of the good/service is greater than the balance of the consumer debit account, enabling the user to transfer supplemental funds from the mobile phone account to the consumer debit account.

Effectuating a transfer of funds from the mobile phone account to the consumer debit account may include effectuating a transfer of funds as an aggregate of one or more predefined fund transfer amounts.

In another implementation, a computing system includes at least one processor and at least one memory architecture coupled with the at least one processor. A first software module is executed on the at least one processor and the at least one memory architecture. The first software module is configured to establish an association between a mobile phone account of a user and a consumer debit account of the user. A second software module is executed on the at least one processor and the at least one memory architecture. The second software module is configured to effectuate a first transfer of funds from the mobile phone account to the consumer debit account. A third software module is executed on the at least one processor and the at least one memory architecture. The third software module is configured to enable a second transfer of funds from the consumer debit account to a third party using at least a portion of the first transferred funds.

One or more of the following features may be included. Establishing an association may include defining a mobile device for the mobile phone account. Establishing an association further may include defining a telephone number for the mobile device. Establishing an association may further include defining a mobile network for the mobile device.

Effectuating a first transfer of funds may include effectuating a first transfer of funds via a web browser. Effectuating a first transfer of funds may include effectuating a first transfer of funds via text message.

Enabling a second transfer of funds may include enabling a second transfer of funds via a web browser. Enabling a second transfer of funds may include enabling a second transfer of funds via text message.

Enabling a second transfer of funds from the consumer debit account to a third party may include receiving an indication of an intent to make a purchase of a good/service, determining a price of the good/service, and comparing the price of the good/service to a balance of the consumer debit account. Enabling a second transfer of funds from the consumer debit account to a third party may further include, if the price of the good/service is greater than the balance of the consumer debit account, notifying the user of the shortage. Enabling a second transfer of funds from the consumer debit account to a third party may further include, if the price of the good/service is greater than the balance of the consumer debit account, enabling the user to transfer supplemental funds from the mobile phone account to the consumer debit account.

Effectuating a transfer of funds from the mobile phone account to the consumer debit account may include effectuating a transfer of funds as an aggregate of one or more predefined fund transfer amounts.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a transfer process coupled to a distributed computing network; and

FIG. 2 is a flowchart of the transfer process of FIG. 1.

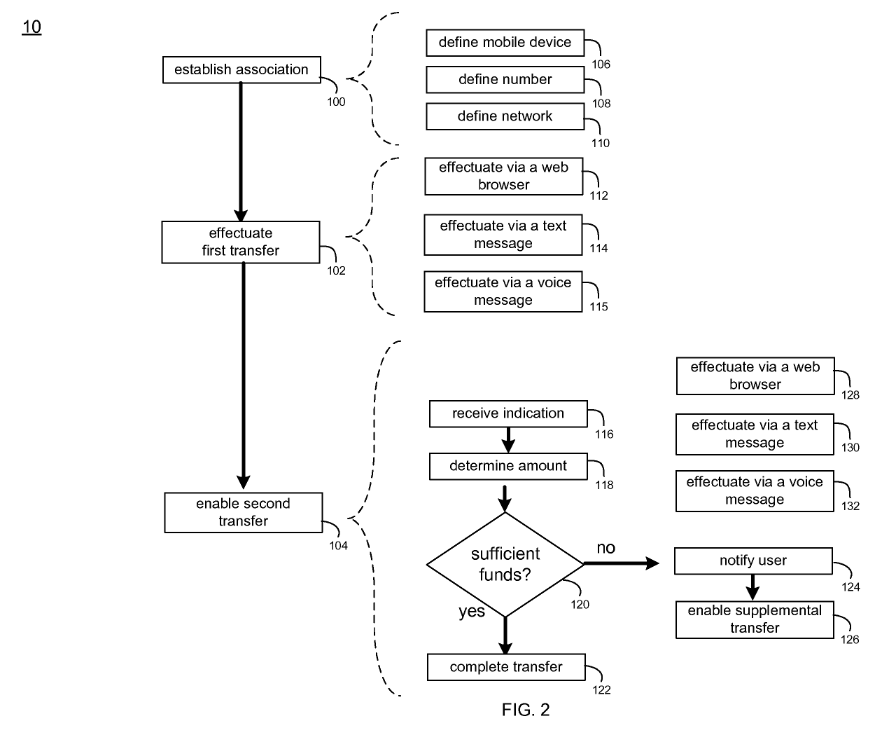

Like reference symbols in the various drawings indicate like elements.

### DETAILED DESCRIPTION OF THE PREFERRED EMBODIMENTS

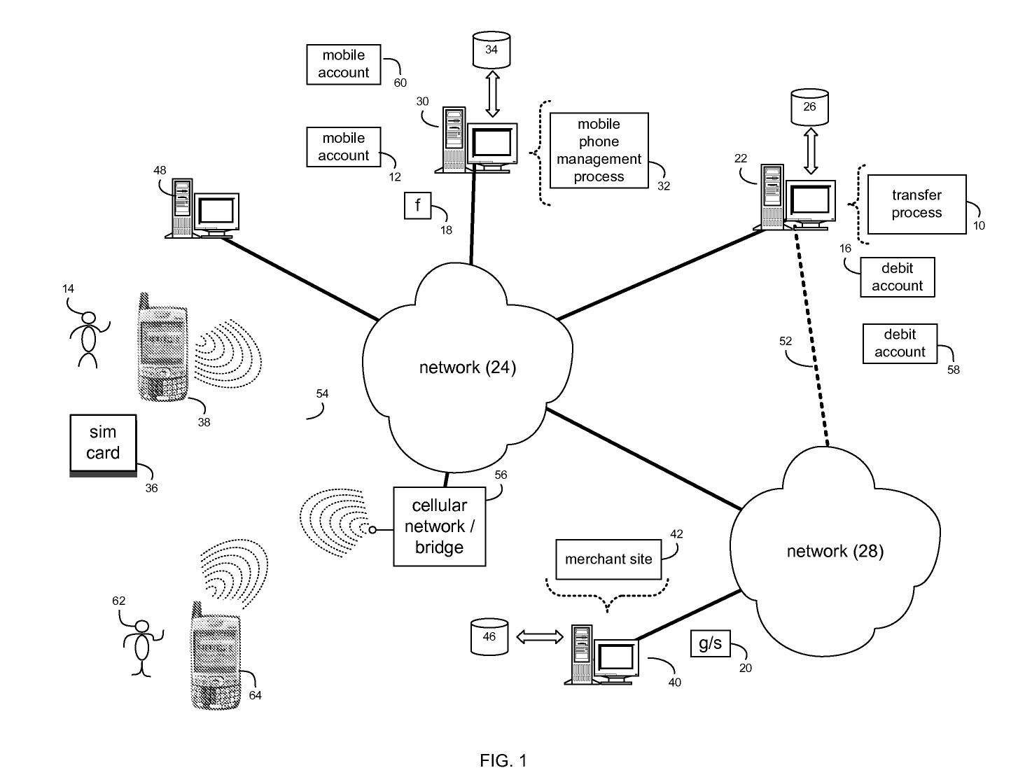

Referring to FIGS. 1 & 2, there is shown transfer process 10 that may establish 100 an association between mobile phone account 12 of user 14 and consumer debit account 16 of user 14. Transfer process 10 may effectuate 102 a first transfer of funds 18 from mobile phone account 12 to consumer debit account 16, thus enabling 104 user 14 to effectuate a second transfer of funds from consumer debit account 16 to a third party using at least a portion of first transferred funds 18. For example, user 14 may transfer funds to another account owned by user 14. Further, user 14 may transfer funds to an account owned by a merchant (thus allowing user 14 to purchase a good/service). Further still, user 14 may transfer funds to an account owned by another person). Transfer process 10 may maintain consumer debit account 16.

Transfer process 10 may reside on and may be executed by server computer 22, which may be connected to network 24 (e.g., the Internet or a local area network). Examples of server computer 22 may include, but are not limited to: a personal computer, a server computer, a series of server computers, a mini computer, and a mainframe computer. Server computer 22 may execute a network operating system, examples of which may include but are not limited to: Microsoft Windows XP Server™; Novell Netware™; or Redhat Linux™, for example.

The instruction sets and subroutines of transfer process 10, which may be stored on storage device 26 coupled to server computer 22, may be executed by one or more processors (not shown) and one or more memory architectures (not shown) incorporated into server computer 22. Storage device 26 may include but is not limited to: a hard disk drive; a tape drive; an optical drive; a RAID array; a random access memory (RAM); and a read-only memory (ROM).

Server computer 22 may execute a web server application, examples of which may include but are not limited to: Microsoft IIS™, Novell Webserver™, or Apache Webserver™, that allows for HTTP (i.e., HyperText Transfer Protocol) access to server computer 22 via network 24. Network 24 may be connected to one or more secondary networks (e.g., network 28), examples of which may include but are not limited to: a local area network; a wide area network; or an intranet, for example.

Server computer 30 may execute mobile phone management process 32. Server computer 30 may be operated and maintained by a mobile network operator (e.g., T-Mobile™, Sprint™, Verizon™) Mobile phone management process 32 may also be operated and maintained by the mobile network operator. Mobile phone management process 32 may be configured to perform one or more operations associated with the operation of a mobile phone network. Mobile phone management process 32 may maintain mobile phone account 12. An example of mobile phone account 12 may include but is not limited to an account that allows user 14 to effectuate telephone calls using a mobile phone. An example of mobile phone management process 32 may include one or more processes executed by the mobile network operator (e.g., T-Mobile™, Sprint™, Verizon™) that allows user 14 to effectuate telephone calls using a mobile phone and mobile phone account 12. Mobile phone management process 32 may allow users to store credit to access operations associated to the mobile phone network (e.g., text messages, internet connection . . . )

The instruction sets and subroutines of mobile phone management process 32, which may be stored on storage device 34 coupled to server computer 30, may be executed by one or more processors (not shown) and one or more memory architectures (not shown) incorporated into server computer 30. Storage device 34 may include but is not limited to: a hard disk drive; a tape drive; an optical drive; a RAID array; a random access memory (RAM); and a read-only memory (ROM).

As discussed above, with pre-paid SIM card 36, the voice/data service provided by the mobile network operator may be purchased in advance. By purchasing credit from the mobile network operator for use on a mobile phone network, a user can access the mobile phone network without ongoing billing. Further, SIM card 36 may allow users to change phones by simply removing the SIM card from one mobile phone and inserting it into another mobile phone. Accordingly, user 14 may purchase (or top-up) pre-paid SIM card 36 with a defined quantity of user credits e.g., $100 US. During use of mobile phone 38 by user 14, the quantity of user credit is reduced in accordance with the rate and type of use of mobile account 12 by user 14. Accordingly, if user 14 initiates a telephone call on mobile account 12 that uses $15 US worth of credits, the available balance of SIM card 36 (and the amount shown in mobile account 12) will be reduced by $15 US to a value of $85 US.

Server computer 40 may execute and serve merchant site 42. Merchant site 42 may be configured to effectuate the sale of goods/services 20 to e.g., user 14. Server computer 40 may be operated and maintained by an online vender (e.g., Amazon™, EBay™, Yahoo™) Server computer 40 may execute a web server application, examples of which may include but are not limited to: Microsoft IIS™, Novell Webserver™, or Apache Webserver™, that allows for HTTP (i.e., HyperText Transfer Protocol) access to server computer 40 via network 24, 28.

The instruction sets and subroutines of merchant site 42, which may be stored on storage device 46 coupled to server computer 40, may be executed by one or more processors (not shown) and one or more memory architectures (not shown) incorporated into server computer 40. Storage device 46 may include but is not limited to: a hard disk drive; a tape drive; an optical drive; a RAID array; a random access memory (RAM); and a read-only memory (ROM).

While merchant site 42 is described above as being a website, this is for illustrative purposes only and is not intended to be a limitation of this disclosure, as other configurations are possible and considered to be within the scope of this disclosure. For example, merchant site 42 may be a more-traditional retail establishment, such as a store front and/or a kiosk that is capable of effectuating the above-described transfer of funds.

User 14 may access transfer process 10, mobile phone management process 32 and/or merchant site 42 directly through various devices, such as mobile phone 38 and/or computing device 48. Examples of computer 48 may include but are not limited to a desktop computer, a laptop computer, a notebook computer, a dedicated network device, and a PDA. Further, any of server computers 22, 30, 40 may be indirectly coupled to network 24 via secondary network 28, as shown for illustrative purposes only with link line 52 (shown in phantom).

Mobile phone 38 and/or computing device 48 may be directly or indirectly coupled to network 24 (or network 28). For example, computing device 48 is shown directly coupled to network 24 via a hardwired network connection. Further, server computer 40 is shown directly coupled to network 28 via a hardwired network connection. Mobile phone 38 is shown wirelessly coupled to network 24 via wireless communication channel 54 established between mobile phone 38 and cellular network/bridge 56, which is shown directly coupled to network 24. Additional devices (not shown) may be wirelessly coupled to network 24, 28 via a wireless communication channel (not shown) established between the device (not shown) and a wireless access point (not shown), which may be coupled to network 24, 28. The wireless access point (not shown) may be e.g., an IEEE 802.11a, 802.11b, 802.11g, Wi-Fi, and/or Bluetooth device that is capable of a establishing wireless communication channel (not shown) between the device (not shown) and the wireless access point (not shown).

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As discussed above transfer process 10 may establish 100 an association between mobile phone account 12 of user 14 and consumer debit account 16 of user 14. Additionally, transfer process 10 may effectuate 102 a transfer of funds 18 from mobile phone account 12 to consumer debit account 16, thus enabling 104 user 14 to effectuate a second transfer of funds from consumer debit account 16 to a third party using at least a portion of first transferred funds 18. For example, user 14 may transfer funds to another account owned by user 14. Further, user 14 may transfer funds to an account owned by a merchant (thus allowing user 14 to purchase a good/service). Further still, user 14 may transfer funds to an account owned by another person). Transfer process 10 may maintain consumer debit account 16.

As discussed above, with pre-paid SIM card 36, the voice/data service provided by mobile network operator may be purchased in advance. Accordingly, user 14 may purchase pre-paid SIM card 36 that includes a defined quantity of user credits e.g., $100 US, which may “charge” (i.e., top-up) mobile phone account 12 to an equivalent value e.g., $100 US. Accordingly, mobile phone account 12 is an account that is created and maintained by mobile phone management process 32 in response to e.g., user 14 purchasing SIM card 36. Mobile phone account 12 may define the phone number of mobile phone 38, the identity of user 14 and various other identifying indicia (e.g., MSISDN).

When establishing 100 an association between mobile phone account 12 of user 14 and consumer debit account 16 of user 14,various procedures may be performed to ensure the accuracy and authenticity of the association.

For example, establishing 100 an association between mobile phone account 12 of user 14 and consumer debit account 16 of user 14 may include defining 106 the mobile device (e.g., mobile phone 38) associated with the mobile phone account (e.g., mobile phone account 12); defining 108 a telephone number for the mobile device (e.g., mobile phone 38); and defining 110 a mobile network for the mobile device (e.g., mobile phone 38). This definition process 106, 108, 110 may occur via a plurality of procedures. For example, one or more MSISDN verification methods may be utilized.

Mobile Originated Text Message (MO)

User 14 may manually send a text message with an activation keyword to a short code number. The verification instructions may be provided by transfer process 10 (e.g., “Text YES to “12345”). The short code (“12345”) used for the verification process may be agreed upon in advance with the mobile network operator. When the message arrives, the activation keyword may be forwarded by the mobile network operator to activate mobile phone 38.

Mobile Terminated Text Message (MT)

The transfer process 10 may send a free text message to mobile phone 38 with a secret PIN code. The PIN code may need to be entered on a web interface (served by server computer 22) to activate mobile phone 38.

Application Programming Interface (API)

The system may send an electronic verification request to the mobile network operator. The mobile network operator may authorize the activation of mobile phone 38 (e.g. via an HTTP call). API verification may require two factors e.g., mobile phone number & an IP address; mobile phone number & Web session ID; and mobile phone number & personal ID number (e.g. a social security umber, passport number, etc.).

Call back (IVR)

An automated call may be made to the mobile phone 38 and a vocal confirmation of the user may be recorded in the system. The verification may also be confirmed with a keypad input.

Depending on the manner in which transfer process 10 is configured, user 14 may only need to verify mobile phone 38 once (e.g., when initially setting up debit account 16 or prior to the first credit transfer request). For example, user 14 may go through a one time registration process to generate a registered account. User 14 may then use this registered account to effectuate money transfers without having to repeat the above-described steps. Alternatively, user 14 may choose not to go through the registration process and, therefore, may be required to repeat one or more of the above-described steps each time that e.g., user 14 wishes to effectuate a transfer.

Assume for illustrative purposes only that user 14 wishes to transfer $50 US of their $100 US funds from mobile phone account 12 to consumer debit account 16. Accordingly, transfer process 10 may effectuate 102 a transfer of $50 US (e.g., funds 18) from funds from mobile phone account 12 to consumer debit account 16.

When transfer process 10 effectuates 102 the transfer of $50 US (e.g., funds 18) from mobile phone account 12 to consumer debit account 16, this procedure may be accomplished in a variety of ways.

For example, effectuating 102 the transfer of funds 18 may include effectuating 112 the transfer of funds 18 via a web browser (not shown). For example, user 14 may utilize a web browser application (not shown) running on e.g., computing device 48 accessible by user 14 to visit and log into a website that allows user 14 to effectuate 102 the transfer of funds 18 from mobile phone account 12 to consumer debit account 16. In this particular example, the balance of mobile phone account 12 will be reduced from e.g., $100 US to $50 US and the balance of consumer debit account 16 will be increased from e.g., $0 US to $50 US.

Alternatively/additionally, effectuating 102 the transfer of funds 18 may include effectuating 114 the transfer of funds 18 via a text message (not shown). For example, user 14 may use mobile phone 38 to send a text message to a predefined number (“12345”) including an amount (“$50 US”) and a predefined recipient (“recipient@email.com”) to effectuate 102 the transfer of funds 18 from mobile phone account 12 to consumer debit account 16. In this particular example, the balance of mobile phone account 12 will be reduced from e.g., $100 US to $50 US and the balance of consumer debit account 16 will be increased from e.g., $0 US to $50 US.

Alternatively/additionally, effectuating 102 the transfer of funds 18 may include effectuating 115 the transfer of funds 18 via a voice message. For example, user 14 may dial an access code (e.g., a phone number) that allows user 14 to access and control transfer process 10 via voice commands. Accordingly, user 14 may dial an access code and say “Transfer $50 US from my mobile account to my debit account” or “Transfer $50 US from my mobile account to recipient@email.com” This verbal command may be processed by transfer process 10 and may effectuate 115 the transfer of funds 18.

In the event that funds can only be removed from (i.e., transferred out of) mobile phone account 12 in predefined increments (e.g., $0.99 US, $1.99 US), transfer process 10 may effectuate 102 the transfer of funds 18 from mobile phone account 12 to consumer debit account 16 as an aggregate of two or more predefined fund transfer amounts (e.g., fifty-one $0.99 US transfers).

Once the transfer is effectuated 102, user 14 may authorize a transfer of funds using the balance that was transferred to consumer debit account 16. For example, user 14 may transfer funds to another account owned by user 14. Further, user 14 may transfer funds to an account owned by a merchant (thus allowing user 14 to purchase a good/service). Further still, user 14 may transfer funds to an account owned by another person).

For illustrative purposes, assume that user 14 visits merchant site 42 served by server computer 40 using mobile phone 38 (if data enabled) or computing device 48. Further assume for illustrative purposes that user 14 selects a book (e.g., good/service 20) that they wish to purchase. Further, assume that user 14 is presented (by merchant site 42) with a plurality of payment options (e.g., Visa, MasterCard, American Express, and consumer debit account 16). Further, assume that user 14 selects consumer debit account 16 as their payment option.

Accordingly, when enabling 104 user 14 to effectuate a second transfer of funds from consumer debit account 16 to the merchant running merchant website 42 (i.e., a third party) to effectuate the purchase of good/service 20, transfer process 10 may receive 116 an indication of an intent of user 14 to purchase of good/service 20; determine 118 the price of good/service 20; and compare 120 the price of good/service 20 to the balance of consumer debit account 16. For example, transfer process 10 may receive 116 an indication that user 14 wishes to purchase the book (e.g., good/service 20) and may determine 118 the price of good/service 20. Transfer process 10 may compare 120 the price of good/service 20 (e.g., $40 US) to the balance of consumer debit account 16 (e.g., $50 US). If the price of good/service 20 (e.g., $40 US) is less than or equal to the balance of consumer debit account 16 (e.g., $50 US), transfer process 10 may complete 122 the purchase and effectuate payment to the merchant selling good/service 20.

However, if 120 the price of good/service 20 is greater than the balance of consumer debit account 16, transfer process 10 may notify 124 user 14 of the shortage and enable 126 user 14 to transfer supplemental funds from mobile phone account 12 to consumer debit account 16.

When enabling 104 user 14 to effectuate the second transfer of funds from consumer debit account 16 to the merchant running ecommerce website 42 (i.e., a third party) to effectuate the purchase of good/service 20, this procedure may be accomplished in a variety of ways. For example, enabling 104 the transfer of funds 18 may include enabling 128 the transfer of funds via a web browser (not shown), enabling 130 the transfer of funds via a text message (not shown) and/or enabling 132 the transfer of funds 18 via a voice message.

Additionally and as discussed above, transfer process 10 may be configured to allow for the transfer of funds (e.g., allow for EFTs) in various manners. For example, transfer process 10 may allow for the transfer of funds from consumer debit account 16 to mobile phone account 12 (in the event of an over transfer). Further, transfer process 10 may allow for the transfer of funds from a merchant account (e.g., an account associated with merchant site 42) to consumer debit account 16 or mobile phone account 12 (e.g., in the event of a refund). Further, transfer process 10 may allow for the transfer of funds from a first consumer debit account (e.g., consumer debit account 16) to a second consumer debit account (e.g., consumer debit account 58) in the event of e.g., a private 0sale or a money transfer activity). Additionally, transfer process 10 may allow for the transfer of funds from a first mobile phone account (e.g., mobile phone account 12) to a second mobile phone account (e.g., mobile phone account 60) in the event of e.g., a private sale or the event of a money transfer activity). Consumer debit account 58 and/or mobile phone account 60 may be associated with another user (e.g., user 62) and another mobile phone (e.g., mobile phone 64).

Once funds 18 are received within consumer debit account 16, funds 18 may be withdrawn from consumer debit account 16 by user 14 via e.g., a standard banking institution, a automated teller machine, a money gram, a wire transfer or transferred back to SIM card 36.

While the system is described above as enabling 104 user 14 to effectuate the second transfer of funds from consumer debit account 16 to the merchant running ecommerce website 42, this is for illustrative purposes only and is not intended to be a limitation of this disclosure, as other configurations are possible and are considered to be within the scope of this disclosure. For example, transfer process 10 may be configured to enable 104 user 14 to effectuate the second transfer of funds from consumer debit account 16 to another debit account (e.g., debit account 58) belonging to another user (e.g., user 62).

While transfer process 10 is described above as working with pre-paid SIM card 36, this is for illustrative purposes only, as other configurations are possible and are considered to be within the scope of this disclosure. For example, transfer process 10 may be configured to work with post-paid SIM cards (not shown). Accordingly, with a post-paid SIM card (not shown) installed within mobile phone 38, user 14 may utilize the post-paid SIN card (not shown) to “charge” (i.e., top-up) debit account 16 to e.g., $100 US. Mobile network operator (e.g., T-Mobile™, Sprint™, Verizon™) may subsequently bill user 14 for the $100 US (plus any mobile phone charges) at the end of their billing cycle.

A number of implementations have been described. Nevertheless, it will be understood that various modifications may be made. Accordingly, other implementations are within the scope of the following claims.

What is claimed is:

1. A computer-implemented method comprising:
establishing an association between a mobile phone account of a user and a consumer debit account of the user;
effectuating a first transfer of funds from the mobile phone account to the consumer debit account; and
enabling a second transfer of funds from the consumer debit account to a third party using at least a portion of the first transferred funds.

2. The computer-implemented method of claim 1 wherein establishing an association includes:
defining a mobile device for the mobile phone account.

3. The computer-implemented method of claim 2 wherein establishing an association further includes:
defining a telephone number for the mobile device.

4. The computer-implemented method of claim 2 wherein establishing an association further includes:
defining a mobile network for the mobile device.

5. The computer-implemented method of claim 1 wherein effectuating a first transfer of funds includes one or more of:
effectuating a first transfer of funds via a web browser; and
effectuating a first transfer of funds via text message.

6. The computer-implemented method of claim 1 wherein enabling a second transfer of funds includes one or more of:
enabling a second transfer of funds via a web browser; and
enabling a second transfer of funds via text message.

7. The computer-implemented method of claim 1 wherein enabling a second transfer of funds from the consumer debit account to a third party includes:
receiving an indication of an intent to make a purchase of a good/service;
determining a price of the good/service; and
comparing the price of the good/service to a balance of the consumer debit account.

8. The computer-implemented method of claim 7 wherein enabling a second transfer of funds from the consumer debit account to a third party further includes:
if the price of the good/service is greater than the balance of the consumer debit account, notifying the user of the shortage.

9. The computer-implemented method of claim 8 wherein enabling a second transfer of funds from the consumer debit account to a third party further includes:
if the price of the good/service is greater than the balance of the consumer debit account, enabling the user to transfer supplemental funds from the mobile phone account to the consumer debit account.

10. The computer-implemented method of claim 1 wherein effectuating a transfer of funds from the mobile phone account to the consumer debit account includes:
effectuating a transfer of funds as an aggregate of one or more predefined fund transfer amounts.

11. A computer program product residing on a computer readable medium having a plurality of instructions stored thereon, which, when executed by a processor, cause the processor to perform operations comprising
establishing an association between a mobile phone account of a user and a consumer debit account of the user;
effectuating a first transfer of funds from the mobile phone account to the consumer debit account; and
enabling a second transfer of funds from the consumer debit account to a third party using at least a portion of the first transferred funds.

12. The computer program product of claim 11 wherein establishing an association includes:
defining a mobile device for the mobile phone account.

13. The computer program product of claim 12 wherein establishing an association further includes:
defining a telephone number for the mobile device.

14. The computer program product of claim 12 wherein establishing an association further includes:
defining a mobile network for the mobile device.

15. The computer program product of claim 11 wherein effectuating a first transfer of funds includes one or more of:
effectuating a first transfer of funds via a web browser; and
effectuating a first transfer of funds via text message.

16. The computer program product of claim 11 wherein enabling a second transfer of funds includes one or more of:
enabling a second transfer of funds via a web browser; and
enabling a second transfer of funds via text message.

17. The computer program product of claim 11 wherein enabling a second transfer of funds from the consumer debit account to a third party includes:
receiving an indication of an intent to make a purchase of a good/service;
determining a price of the good/service; and
comparing the price of the good/service to a balance of the consumer debit account.

18. The computer program product of claim 17 wherein enabling a second transfer of funds from the consumer debit account to a third party further includes:
if the price of the good/service is greater than the balance of the consumer debit account, notifying the user of the shortage.

19. The computer program product of claim 18 wherein enabling a second transfer of funds from the consumer debit account to a third party further includes:
if the price of the good/service is greater than the balance of the consumer debit account, enabling the user to transfer supplemental funds from the mobile phone account to the consumer debit account.

20. The computer program product of claim 11 wherein effectuating a transfer of funds from the mobile phone account to the consumer debit account includes:
effectuating a transfer of funds as an aggregate of one or more predefined fund transfer amounts.

21. A computing system comprising:
at least one processor;
at least one memory architecture coupled with the at least one processor;
a first software module executed on the at least one processor and the at least one memory architecture, wherein the first software module is configured to establish an association between a mobile phone account of a user and a consumer debit account of the user;
a second software module executed on the at least one processor and the at least one memory architecture, wherein the second software module is configured to effectuate a first transfer of funds from the mobile phone account to the consumer debit account; and
a third software module executed on the at least one processor and the at least one memory architecture, wherein the third software module is configured to enable a second transfer of funds from the consumer debit account to a third party using at least a portion of the first transferred funds.

22. The computing system of claim 21 wherein the first software module is further configured to:
define a mobile device for the mobile phone account.

23. The computing system of claim 22 wherein the first software module is further configured to:
define a telephone number for the mobile device.

24. The computing system of claim 22 wherein the first software module is further configured to:
define a mobile network for the mobile device.

25. The computing system of claim 21 wherein the second software module is further configured to:
effectuate a first transfer of funds via a web browser; and/or
effectuate a first transfer of funds via text message.

26. The computing system of claim 21 wherein the third software module is further configured to:
enable a second transfer of funds via a web browser; and
enable a second transfer of funds via text message.

27. The computing system of claim 21 wherein the third software module is further configured to:
receive an indication of an intent to make a purchase of a good/service;
determine a price of the good/service; and
compare the price of the good/service to a balance of the consumer debit account.

28. The computing system of claim 27 wherein the third software module is further configured to:
if the price of the good/service is greater than the balance of the consumer debit account, notify the user of the shortage.

29. The computing system of claim 28 wherein the third software module is further configured to:
if the price of the good/service is greater than the balance of the consumer debit account, enable the user to transfer supplemental funds from the mobile phone account to the consumer debit account.

30. The computing system of claim 21 wherein the second software module is further configured to:
effectuate a transfer of funds as an aggregate of one or more predefined fund transfer amounts.
